(19) United States
(12) Patent Application Publication
(10) Pub. No.: US 2012/0060375 A1
(43) Pub. Date: Mar. 15, 2012

(54) Innard clean out tool

(76) Inventor: Evan Anderson, (US)

(21) Appl. No.: 12/807,581

(22) Filed: Sep. 10, 2010

(51) Int. Cl. B26B 3/00

(52) U.S. Cl. 30/172

(57) ABSTRACT

An innard clean out tool for use in cleaning the interior of a pumpkin or other fruit or vegetable. The innard clean out tool having a shaft which is removable attached to an electric or cordless drill driver and a plurality of cutting blades for generally horizontal cutting. The cutting blades are generally disposed in a closed loop configuration sharpened on one or both sides with an angled segment to remove the fibrous strands within the interior of the pumpkin while simultaneously thinning portions of the pumpkin's interior wall.

### BACKGROUND OF THE INVENTION

1. Field of the Invention

A cleaning apparatus to assist in cleaning the innards of a pumpkin or other fruit or vegetable for decorative or cooking purposes, is used by manually rotating the apparatus or attaching the apparatus to an electric or cordless power source.

2. Description of Related Art

This invention relates generally to cleaning devices and, more particularly, to a pumpkin clean out apparatus which enables an individual to quickly and easily remove the innards of a pumpkin so the pumpkin can be carved or otherwise decorated.

Carving a pumpkin is traditional in the autumn season and especially at Halloween. While families enjoy the tradition of carving pumpkins together, the need to remove the pumpkin innards before carving the pumpkin is time consuming, unpleasant and untidy.

Many devices have been proposed in the prior art for cutting and carving pumpkins. However, very few devices have been proposed for quickly and easily removing the innards of the pumpkin. No devices have been proposed which simultaneously remove the fibrous strands within the pumpkin while also thinning the inner wall of the pumpkin without damaging the pumpkin's skin or outer wall.

Accordingly, it is the primary object of the present invention to provide an inexpensive and non-corrosive device for quickly and cleanly removing the fibrous strands from within the pumpkin through the use of a series of rotating blades while also thinning the pumpkins inner wall by means of a plurality of extruding blade ends extending from the rotating blades.

### SUMMARY OF THE INVENTION

An innard clean out apparatus according to the present invention includes a shaft having a first end and a second end. The first end of the shaft is cylindrical or, in an alternative embodiment, may contain a hexagonal shape portion and fixedly attached to the second end of the shaft are a grouping of cutting blades.

The first end of the shaft is securely inserted into the jaws of a drill or otherwise securely placed within a manual or electric power source. The cutting blades of the cutter head are flat cutting blades with one or two sharpened edges for cutting in either the clockwise or counterclockwise rotation direction. Each cutting blade is formed into a semi-circular shape having a first end and a second end. The first end of each cutting blade is slightly curled so that the mid-point of the first end is fixedly attached to the top end of the shaft. The second edge of the first end rises above and away from the top end of the shaft. When the blades are rotated, the second edge of the first end penetrates and cuts away at the pumpkin's inner wall. The second end of each cutting blade is fixedly attached to the shaft. The number of cutting blades can be of any number but is five in the preferred embodiment.

Therefore, a general object of this invention is to provide an apparatus for quickly and easily removing the fibrous strands and seeds within the interior of a pumpkin.

A further objective of the present invention is to provide an apparatus which simultaneously thins the inner wall of the pumpkin.

A further objective of this invention is to provide a pumpkin clean out device which is easy to use and inexpensive for the consuming public.

It is the further object of the present invention to provide cutting blades which are semi-circular to allow simultaneous cutting of the side, top and bottom of the pumpkin or other fruit or vegetable.

It is the further object of the present invention to provide a device that can be operated manually or by a power source, such as an electric or cordless drill.

These, and other, aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a perspective view of the cutting blades of an innard clean out tool in accordance with a preferred embodiment of the present invention.

FIG. 2 is a perspective view of the cutting blades illustrating the first side of the cutting blade's first end extending above and away from the second end of the shaft in accordance with a preferred embodiment of the present invention.

FIG. 3 is a cut away perspective view of the cutting blades illustrating the first side of the cutting blade's first end extending above and away from the second end of the shaft in accordance with a preferred embodiment of the present invention.

FIG. 4 is a side perspective view of the innard clean out tool in accordance with a preferred embodiment of the present invention.

FIG. 5 is a bottom plan view of the innard clean out tool in accordance with a preferred embodiment of the present invention.

FIG. 6 is a cross-sectional side view of the innard clean out tool attached to a drill in accordance with a preferred embodiment of the present invention.

### DETAILED DESCRIPTION OF THE PREFERRED EMBODIMENTS

The present invention and the various features and advantageous details thereof are explained more fully with reference to the non-limiting embodiments described in the following description. The present invention, the innard clean out tool 10 is comprised of a plurality of components. Such components are individually configured and correlated with respect to each other so as to attain the desired objective.

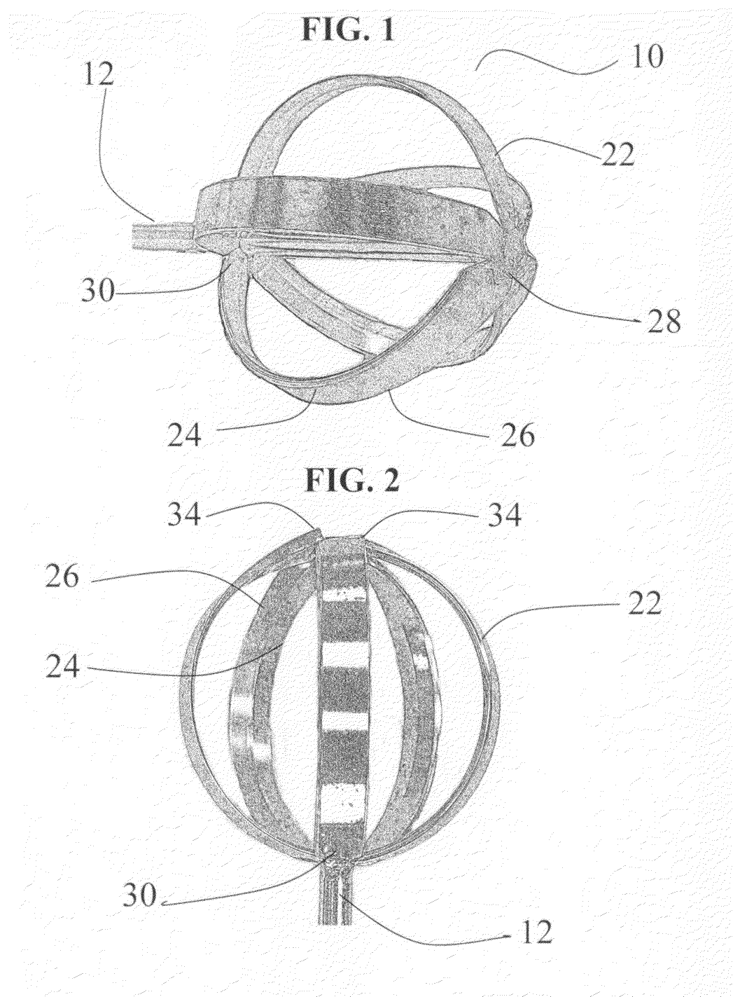

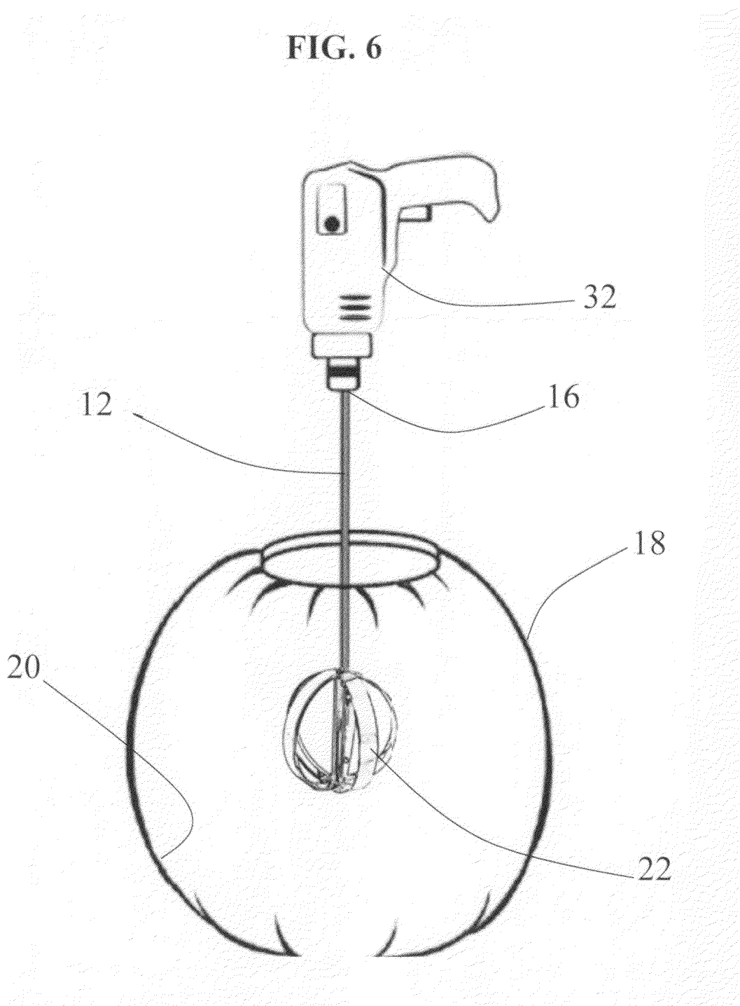

FIGS. 1 through 6 show a device of the present invention which can be used for cleaning out the interior contents of a pumpkin, squash, and other fruits and vegetables while simultaneously thinning the interior walls for decorative or culinary purposes. The device consists of a cylindrical shaft 12 having top 14 and bottom opposing ends 16. The cylindrical shaft 12 is of an adequate length so as to allow the top end 14 of the cylindrical shaft 12 to reach the lowest point of the pumpkin's inner wall 20 while the bottom end 16 of the cylindrical shaft 12 remains outside of the pumpkin 18. The shaft 12 is generally made of steel and is coated with rust inhibitor or is otherwise constructed of non-corrosive durable materials.

Referring to FIGS. 1, 2 and 3, the innard clean out tool includes a series of cutting blades 22. The cutting blades 22 are flat cutting blades with a first sharpened edge 24 and a second sharpened edge 26. The first 24 and second 26 sharpened edges are parallel. Each cutting blade 22 has a first end 28 and an opposing second end 30. The cutting blades 22 are in a semicircular configuration with mid-point of the first end 28 of each cutting blade 22 fixedly attached to the top end 14 of the cylindrical shaft 12.

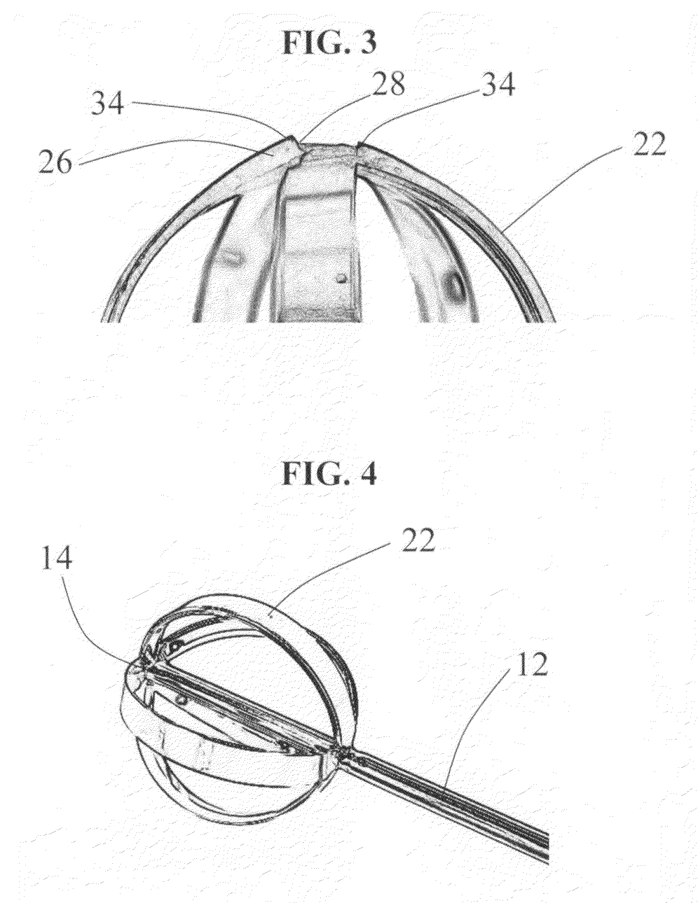

Referring to FIGS. 2 and 3, the corner formed at the intersection of the first end 28 and the second edge 26 of each cutting blade 22 is not attached to the shaft's top end 14 and is angled away from said top end 14. The angled segment 34 of each cutting blade 22, when rotated, cuts away portions of the inner wall 20 of the pumpkin.

The second end 28 of each cutting blade 22 is fixedly attached to the cylindrical shaft 12 at a point above the bottom end 16. The number of cutting blades 22 can be of any number but consists of five cutting blades 22 in the preferred embodiment.

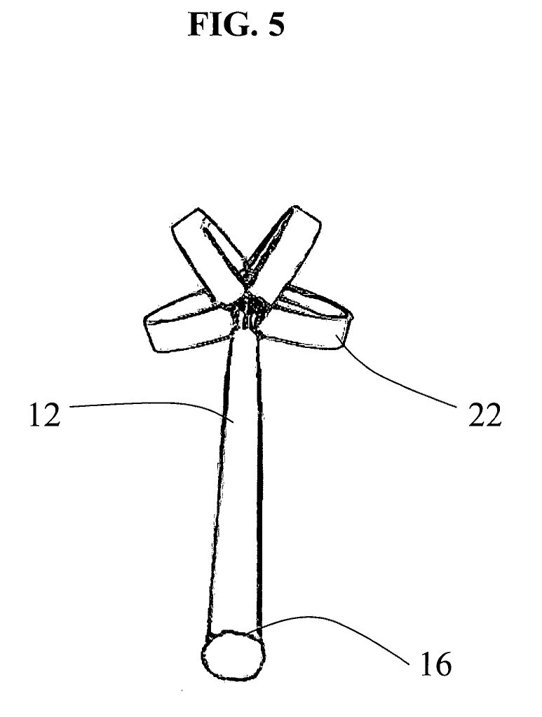

Referring to FIG. 5, the bottom end 16 of the shaft 12 is cylindrical shaped or, in an alternative embodiment, may contain a hexagonal shaped portion. The bottom end 16 of the cylindrical shaft 12 is inserted and securely fastened to a common drill driver 32 which is adapted to receive a tool for selectively causing the rotation thereof. In the preferred embodiment, the bottom end 16 of the cylindrical shaft 12 is securely fastened within jaws of an electric or cordless drill 32.

When the device is in use, the bottom end 16 of the cylindrical shaft 12 is removably attached to an electric or cordless drill driver 32. Power is applied to the drill driver 32 through preferably an on/off control switch or trigger.

In a drill driver 32 having a forward and reverse switch, the power source control lever is first switched to a forward position. In devices that have multiple speeds, the low speed control is selected. Next, the on/off control switch is then depressed by preferably a finger of the user to apply power to the cylindrical shaft 12. The cutting blades 22, which have been resting within the interior of the pumpkin, are rotated about the interior of the pumpkin. As the cutting blades 22 are moved about the interior of the pumpkin, the pumpkin fibrous strands and seeds are separated from the interior wall of the pumpkin. Simultaneous with removing the fibrous strands and seeds, the angled segment 34 of the second edge 26 of each cutting blade 22 cuts away portions of the pumpkin's inner wall 20, thereby making it easier to carve the pumpkin.

Once the pumpkin's fibrous strands and seeds have been separated and the inner wall thinned and the cutting blades 22 removed, the pumpkin can be turned upside down, thereby allowing the separated innards to fall from the interior of the pumpkin.

Once the pumpkin innards are removed, the cutting blades 22 can be reintroduced into the interior of the pumpkin to further thin the interior wall, if necessary, for decorative and/or culinary purposes. If no additional thinning is required, the innard clean out tool 10 is easily removed from the drill driver 32 and stored in a small space for future use.

Although the best mode contemplated by the inventor of carrying out the present invention is disclosed above, practice of the present invention is not limited thereto. It will be manifest that various additions, modifications and rearrangements of the features of the present invention may be made without deviating from the spirit and scope of the underlying inventive concept.

The individual components mentioned herein need not be fabricated from the disclosed materials, but could be fabricated from virtually any suitable and strong materials.

Moreover, the individual components need not be formed in the disclosed shapes, or assembled in the disclosed configuration, but could be provided in virtually any shape, and assembled in virtually any suitable configuration. It is intended that the appended claims cover all such additions, modifications and rearrangements.

Index of Elements for Innard Clean Out Tool

| | |
|---|---|
| 10 | Clean Out Tool |
| 12 | Cylindrical Shaft |
| 14 | Top End Cylindrical Shaft |
| 16 | Bottom End Cylindrical Shaft |
| 18 | Pumpkin (Fruit or Vegetable) |
| 20 | Inner Wall |
| 22 | Cutting Blades |
| 24 | First Cutting Blade Edge |
| 26 | Second Cutting Blade Edge |
| 28 | Cutting Blade First End |
| 30 | Cutting Blade Second End |
| 32 | Drill Driver |
| 34 | Angled Segment |
| 36 | |
| 38 | |
| 40 | |
| 42 | |
| 44 | |
| 46 | |
| 48 | |
| 50 | |

1. A device for cleaning out the innards of a pumpkin or other fruits and vegetables, comprising:
A cylindrical, rotatable shaft having a top end and a bottom end with the bottom end removable couplable to a standard electric or cordless hand-held drill with chuck jaws;
A plurality of cutting blades, each cutting blade from the plurality of cutting blades having a half circle configuration and a first end with the midpoint of said first end fixedly attached to the cylindrical shaft at a non-zero distance from the top end of the cylindrical shaft, and an opposing second end fixedly attached to the cylindrical shaft;
Each cutting blade from the plurality of cutting blades having a first tapered edge and a second tapered edge with at least one of said edges being configured to cut throughout the interior of a pumpkin or other fruit or vegetable without restriction when the cylindrical shaft is rotated; and
Each cutting blade from the plurality of cutting blades having an angled segment which angled segments are configured to extend above the top end of the cylindrical shaft to allow the angled segments to penetrate and cut the inner wall of the pumpkin or other fruit or vegetable when the cylindrical shaft is rotated.

2. The device of claim 1, wherein each cutting blade from the plurality of cutting blades has a curved configuration and has at least one sharpened tapered edge.

3. The device of claim 1, wherein the device is constructed of non-corrosive materials or coated with a rust inhibitor.

4. The device of claim 1, wherein the cylindrical rotatable shaft can be removably coupled to a standard electric or cordless hand-held drill_adapted to receive the top end of the cylindrical shaft.

5. A device comprising:
A cylindrical shaft having a top end and a bottom end, the bottom end of the cylindrical shaft configured to be removably coupled to a standard electric or cordless hand-held drill;
A plurality of cutting blades, each cutting blade from the plurality of cutting blades having a curved configuration and being fixedly attached to the cylindrical shaft, the plurality of cutting blades collectively having a length and a maximum width, the maximum width defined at a mid-point of the length of the plurality of cutting blades, the plurality of cutting blades configured to cut throughout the interior of a fruit or vegetable without restriction when the cylindrical shaft is rotated by the standard electric or cordless hand-held drill; and
Each cutting blade from the plurality of cutting blades having an angled segment which angled segments are configured to extend above the top end of the cylindrical shaft to allow the angled segments to penetrate and cut the inner wall of the pumpkin or other fruit or vegetable when the cylindrical shaft is rotated.

6. The device of claim 5, wherein the cylindrical shaft has a length sufficient to allow the top end of the cylindrical shaft to be disposed within the interior of a fruit or vegetable while the bottom end of the cylindrical shaft is maintained outside of the interior of the fruit or vegetable.

7. The device of claim 5, wherein each cutting blade from the plurality of cutting blades has a curved configuration and has at least one sharpened tapered edge.

8. The device of claim 5, wherein each cutting blade from the plurality of cutting blades has a first end and an opposing second end with the mid-point of the first end attached to the cylindrical shaft at a non-zero distance from the top end and the second end fixedly attached to the cylindrical shaft at a point below the top end of the cylindrical shaft.

9. The device of claim 5, wherein the plurality of cutting blades includes five cutting blades.

10. The device of claim 5, wherein the device is constructed of non-corrosive materials.

11. The device of claim 5, wherein the cylindrical shaft is configured to be removably coupled to a standard electric or cordless hand-held drill.

12. A device comprising:
A shaft having a top end and a bottom end, the bottom end of the shaft configured to be removably coupled to any standard electric or cordless_hand-held drill with chuck jaws;
A plurality of cutting blades, each cutting blade from the plurality of cutting blades having a half circle configuration and being fixedly attached to the cylindrical shaft, the plurality of cutting blades collectively having a length and a maximum width, the maximum width defined at a mid-point of the length of the plurality of cutting blades,
the plurality of cutting blades configured to cut throughout the interior of a fruit or vegetable without restriction when the shaft is rotated; and
Each cutting blade from the plurality of cutting blades having an angled segment which angled segments are configured to extend above the top end of the cylindrical shaft to allow the angled segments to penetrate and cut the inner wall of the pumpkin or other fruit or vegetable when the cylindrical shaft is rotated.

13. The device of claim 12, wherein the plurality of cutting blades includes at least 5 cutting blades.

14. A method, comprising:
removably coupling the bottom end of a shaft of a cutting device to any standard electric or cordless hand-held drill with chuck jaws, the cutting device having a plurality of cutting blades with angled segments disposed at the top end of the shaft;
inserting the plurality of cutting blades into an interior region of a fruit or vegetable, the interior region including innards and interior wall of the fruit or vegetable;
actuating the hand-held drill such that the shaft rotates the plurality of cutting blades and angled segments throughout the interior of the pumpkin or other fruit or vegetable without restriction;
after the actuating, moving the plurality of cutting blades freely and unrestricted to any location within the interior region of the fruit or vegetable;
and actuating the electric or cordless hand-held drill such that the shaft is rotated and the plurality of cutting blades and angled segments cut at least a portion of the interior region of the fruit or vegetable;
after the actuating, removing the plurality of cutting blades from the interior region of the fruit or vegetable; and
decoupling the shaft from the electric or cordless hand-held drill.

15. The method of claim 14, wherein during the actuating, at least a portion of the innards are separated from at least one of top, a bottom or a side of the interior region of the fruit or vegetable.

16. The method of claim 14, wherein the drill is any standard electric or cordless hand-held drill, the actuating includes actuating a power switch.

17. The method of claim 14, wherein each blade from the plurality of cutting blades has a half circle shape.

18. The method of claim 14, wherein the inserting includes inserting the plurality of cutting blades into a first location within the interior region of the fruit or vegetable.
